(19) United States
(12) Patent Application Publication
(10) Pub. No.: US 2008/0215889 A1
(43) Pub. Date: Sep. 4, 2008

(54) Efficient Watermark Detection

(75) Inventors: Mehmet Utku Celik, Eindhoven (NL); Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,769

(22) PCT Filed: Oct. 6, 2006
(86) PCT No.: PCT/IB06/53659

§ 371 Date: Apr. 10, 2008

(30) Foreign Application Priority Data
Oct. 13, 2005 (EP) 05109511.5

(51) Int. Cl. H04L 9/00

(52) U.S. Cl. 713/176

(57) ABSTRACT

A system and a method of effectively detecting watermarks in a significant amount of data signals. The method, in overview, consists in pre-filtering the significant amount of data signals in order to eliminate from the final watermark detection the segments of the data signals which have no significant relevance to the owner of the copyrights of the watermark under investigation, and then performing the actual watermark detection over the remaining segments of data signals relevant to the investigation. The pre-filtering feature being implemented by a definition of one or more goal descriptors, extraction of one or more descriptors from the data signals and its content and a comparison between goal descriptors and extracted descriptors.

### FIELD OF THE INVENTION

The present invention relates to a watermark detection method; in particular, the invention relates to a watermark detection method utilizing a pre-filtering step before the detection step. The invention further relates to a computer readable code for implementing the method and to a system for watermark detection.

### BACKGROUND OF THE INVENTION

Digital watermarking has proven an effective deterrent against illegal distribution of copyrighted material in digital form for instance over computer networks, electronic content distribution (ECD) applications or hand-to-hand public distribution.

Generally digital watermarking consists in altering an original data signal by embedding information in the original data signal, which might be used to identify the content creator or owner and/or to protect the copyright of the creator or owner of the original data signal. Digital watermarks are designed to alter insignificantly the original data signal in a way that the digital watermark is imperceptible to humans or a computer analysing the watermarked signal. Watermarking is implemented generally by a pre-coding stage where a watermark is generated and a transcoding watermark embedding stage where the watermark is added to the original data signal in a single or a series of locations within the original data signal, the location or locations where the watermark is embedded are generally accessible with previous knowledge of a secret key. Finally a watermark detector extracts the watermark from the watermarked data signal allowing copyright identification.

In order to efficiently track re-distribution of original data signals within a computer network, e.g. the Internet or an specific number of servers within the Internet, it is necessary to scan through a very high number of data signals, physically located in a number of computers and/or servers, detecting and decoding the embedded watermarks, if present, in order to track the originality of the digital content of the object and its distribution transactions. This process is extremely time consuming and an effective system for watermark detection that reduces the required time and simplifies tracking of original digital content within a computer network will be of great interest and can be used as an effective deterrents against illegal distribution of copyrighted material.

A method that allows for selective downloading of data signals in relation to an illegal contents tracing system has been described in the article by Ho Woo Jang et. Al, “An illegal contents tracing system based on web robot and fingerprinting scheme”, IEEE International Conference on Information Reuse and Integration 2003, IRI 2003, pages 415-419. The method allows for a pre-selective elimination of data signals, files, according to the size of the file or its file extension, as a previous step to a watermark detection process over the remaining downloaded files. Eliminating in forehand files with a certain extension without checking the actual contents of the file, can lead to not consider files on which a malicious user has changed the extension in order to camouflage the contents of the file. Observing an improvement in processing time by eliminating in forehand small sized files, less than 10 Kb, can require that a vast majority of the files within an investigated computer network are of that size, this condition being unrealistic considering the evolution of the size of data signals and the increased communication speeds within a computer network.

Hence, an improved and more efficient method that provides forensic tracking watermark detection would be advantageous.

### SUMMARY OF THE INVENTION

The present invention seeks to provide improved means for efficient watermark detection. Preferably, the invention alleviates, mitigates or eliminates one or more of the above or other disadvantages singly or in any combination. Especially, it may be seen as an object of the invention to provide a method and a system for forensic tracking watermark detection that overcomes the problems of the prior art in a time and cost effective way.

Accordingly there is provided, in a first aspect, a method for watermark detection, the method being based on a goal descriptor, the method comprising a pre-filtering step and a detection step, wherein:

the pre-filtering step comprising the steps of:
receiving a data signal;
deriving a signal descriptor from the data signal;
comparing the signal descriptor to the goal descriptor so as to determine whether or not the data signal is a signal to be considered as candidate data signal in the watermark detection; and
the detection step comprising the steps of: detecting the watermark in the candidate data signal, otherwise disregarding the data signal.

The present invention is based on the observation that a particular copyright or content owner has the rights for only a fraction of the contents available on a computer network or an electronic content distribution (ECD) application. As a result the copyright or content owner can exclude the majority of data signals, files, on an investigated computer network or ECD application in a pre-filtering step to the actual watermark extraction step.

Furthermore the present invention is also based on the observation that watermark detection within a particular file is often feasible only on parts of the contents of the file that bear certain characteristics, e.g. have enough power in the mid-frequency bands when watermarking an audio file. Therefore, parts of the contents within a file may also be excluded, reducing even further the amount of data that finally needs to be investigated for watermark detection.

In the following description data signals, data carrying signals and files should be understood as a single concept referring to an amount of organized digital data being temporarily or permanently stored in, and/or accessed from, a hard disk, diskette, DVD, CD-ROM, USB-Key or any other similar read-only or read-and-write memory elements.

In the following description presented in this application the term watermark will refer to any kind of information embedded within a data signal, for instance with the purpose of copyright protection and/or identification of the owner of the content of the data signal, or with the purpose of providing additional info relating to the data signal.

The invention is particularly but not exclusively advantageous for a number of reasons. An important advantage is that the invention allows discarding the data signals in which a copyright owner has no rights on according to a user based predefined list of goal descriptors. This will reduce the number of data signals the watermark detector needs to actually process, allowing for a faster evaluation of a predetermined group of data signals mistaken to carry the watermark searched by the copyright owner.

The optional features as defined in claim 2 are advantageous since the pre-filtering step includes actions that can allow to reduce the amount of data on which final watermark detection process has to be applied to, by dividing the candidate data signals into one or more segments and selecting the segments that match certain predefined characteristics.

The optional features as defined in claims 3, 4 and 5 disclose advantageous embodiments according to possible derivations of the descriptor of the data signal. In claim 3 the descriptor of the data signal may be derived from the meta-data associated with the data signal. In claim 4 the descriptor of the data signal may be derived from properties of the data signal. In claim 5 the descriptor of the data signal may be derived from the representation of the data signal.

The optional features as defined in claim 6 are advantageous since by performing two or more pre-filtering steps successively the number of candidate data signals may be reduced significantly including data signals with a high probability of containing the watermark searched by the copyright owner.

The optional feature as defined in claim 7 discloses advantageous embodiments according to possible grouping of steps of the method wherein the derivation of a descriptor from the data signals and the descriptor of the segments of the data signal is done simultaneously in a single step before any comparison to a goal descriptor or a goal segment descriptor.

The optional features as defined in claim 8 are advantageous since the watermark detection step includes decoding a payload encoded in the watermark.

The optional features as defined in claim 9 are advantageous as the user may find a list of possible goal descriptors in a database and choose the goal descriptor in accordance to the type of pre-filtering needed.

The optional features as defined in claim 10 disclose advantageous embodiments according to the possible content of the data signal. The data signal may comprise at least one of: audio, video, images, multimedia software, multidimensional graphical models, software structures.

In a second aspect of the invention is provided a computer readable code for implementing the method of the first aspect.

In a third aspect of the invention there is provided an input module for receiving the data signal, a computing unit for storing or for providing access to a goal descriptor and detecting a watermark in the received data signal, and an output module system for outputting a signal representing whether or not a watermark is present in the data signal;

and wherein the computing unit further conducts a pre-filtering step and a detection step:
the pre-filtering step comprising the steps of:

receiving a data signal;

deriving a signal descriptor from the data signal;

comparing the signal descriptor to the goal descriptor so as to determine whether or not the data signal is a signal to be considered as candidate data signal in the watermark detection.

In general the various aspects of the invention may be combined and coupled in any way possible within the scope of the invention.

The method of the first aspect of the invention may be implemented for an input module, a computing unit and an output module of the third aspect of the invention.

These and other aspects, features and/or advantages of the invention will be apparent from and elucidated with reference to the embodiments described hereinafter.

### BRIEF DESCRIPTION OF THE DRAWINGS

The present invention will now be explained, by the way of example only, with reference to the accompanying Figures wherein:

FIG. 1 is a representation of the conceptual observation that a particular copyright or content owner has the rights for only a fraction of the contents available on a computer network or an electronic content distribution (ECD) application;

FIG. 2 is a flow chart illustrating a method for watermark detection according to a first aspect of the invention;

FIG. 3 is a flow chart illustrating a method for pre-filtering from an initial substantial amount of data signals a group of data signals with required characteristics related to a specific watermark according to the first aspect of the invention;

FIG. 4 is a schematic representation of multi-stage pre-filter where in each stage of the filter additional signals are eliminated from an initial substantial amount of data signals according to an embodiment of the invention; and

FIG. 5 is a schematic diagram illustrating a system for watermark detection according to a second embodiment of the invention and its interaction within a computer network or ECD application.

### DESCRIPTION OF EMBODIMENTS OF THE INVENTION

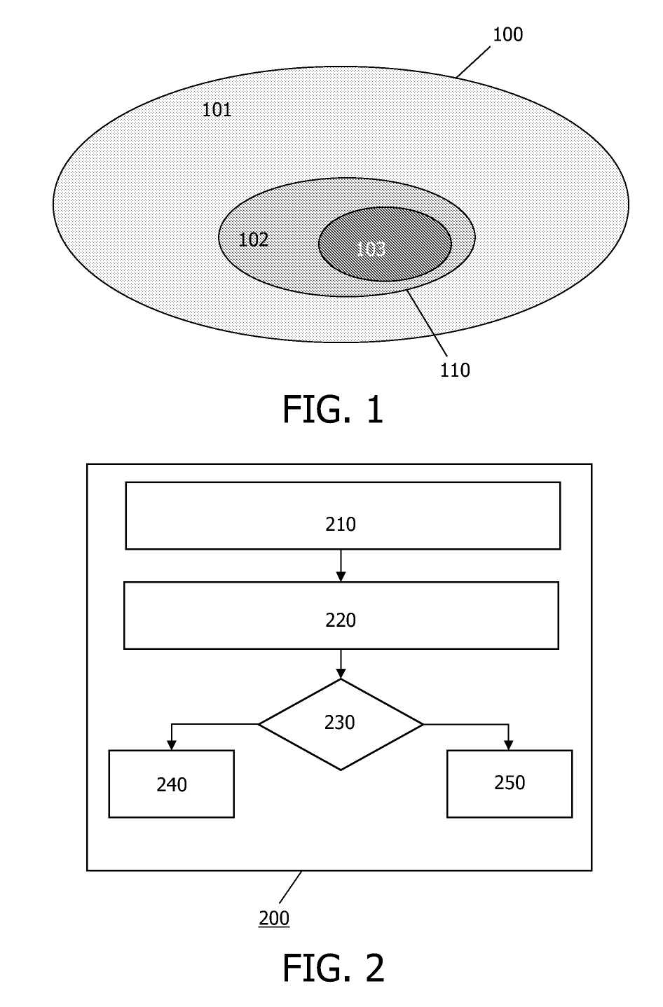

The present invention utilizes the fact that a typical copyright or content owner has the rights for only a fraction of the contents available on a computer network or an electronic content distribution (ECD) application. This is conceptually illustrated in FIG. 1. The total amount of data signals that are contained at a certain point in time within a computer network or an ECD application 100 comprises those data signals for which the copyright owner has the rights for 110 and a remaining amount of data signals for which the copyright owner has no rights 101. Thus by introducing a pre-filtering function in order to eliminate those data signals for which the copyright owner has no rights for 101 the amount of processing required involving the actual watermark extraction will be significantly reduced.

Furthermore, the copyright owner has access and/or knowledge of the method used in the watermark generation process and therefore will be able to identify if only certain parts of the data signals should be considered in the watermark extraction process. Each data signal for which the copyright owner has rights for can be divided into parts or segments estimated to contain watermark information and parts or segments estimated to contain no watermark information. The total amount of data signals for which the copyright owner has rights for 110 comprises a group of data signal parts 102 which are not relevant for the particular watermark extraction process and a group of data signal parts 103 which are relevant and considered in the watermark extraction process.

A flow chart presenting the main steps of a method for watermark detection is indicated generally by 200 in FIG. 2. Users of the method will as a pre-requisite be searching for data signals characterized by a certain defined watermark indication of specific copyright content. The method comprises steps of: accessing a data signal placed within a computer network or ECD application 210, pre-filtering 220 the data signal in order to determine if it should be considered as a candidate data signal in the watermark detection, decide 230 whether or not the data signal is to be considered a candidate data signal, and detecting the watermark 240 if the data signal is considered a candidate data signal 230 or disregarding 250 the data signal if it is not considered a candidate data signal In one possible implementation of the method the data signals that are considered candidates are included in a list of candidate data signals and the watermark detection process is carried out for all the candidate data signals after the pre-filtering process.

In another possible implementation of the method the user accesses the computer or/and servers within the computer network or EDC in which it is allowed access and accesses the data signals available within these computers and/or servers. The total amount of data signals accessed are then pre-filtered in order to determine contents of the data signals in which the user of the method has a final interest in and that match the specific watermark object of the search. Finally the actual watermark extraction is applied to the contents of the data signals remaining from the pre-filtering step, and a list of data signals in which the watermark was identified is presented to the user, who may then decide whether to take any further action.

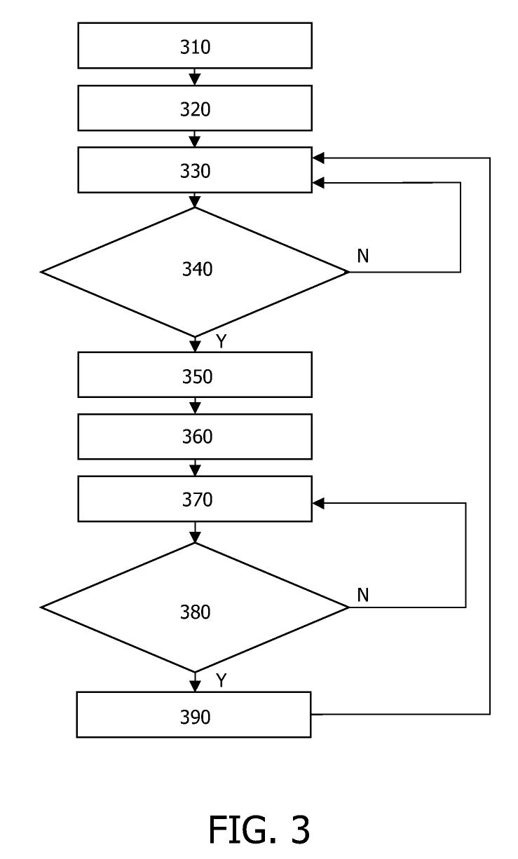

In FIG. 3 a flow chart is shown, illustrating a method for pre-filtering from an initial substantial amount of data signals, a group of data signals with required characteristics related to a specific watermark. The method comprises steps of: defining a goal descriptor for the data signals, G_{d}, and a goal descriptor for the parts or segments of the data signals, Gₛ, 310, accessing a plurality of computers or servers to download a plurality of data signals in which the user of the method wants to search the specific watermark and storing the data signals for further availability in a local memory 320. The method furthermore comprises steps of: accessing and specific data signal stored in the local memory and deriving a descriptor for the data signal, C_{d}, according to definition of the goal descriptor of data signals 330, comparing the goal descriptor to the descriptor of the data signal 340 and including the data signal in a database containing data signals for which the user might have rights 350. The method may also include steps of: dividing the data signal into one or more potentially overlapping segments, Sᵢ, 360, accessing a segment of the data signal and deriving a descriptor for the segments 370, comparing the goal descriptor of the segment to the actual descriptor of the segment 380 and including the segment of the data signal in a database containing segments of data signals for which the user might have rights for 390.

From a list of possible data signal goal descriptors and/or segment goal descriptors a particular goal descriptor and/or segment goal descriptor is/are selected 310 according to the user's considerations. The copyright owner might specify a specific number of computers and/or servers to be investigated and their location in the computer network or ECD under investigation. The computer/servers are then accessed and relevant data signals are accessed and may be downloaded to a local memory for future processing 320. A specific data signal may be accessed from the memory and a descriptor derived from it 330 according to its current definition, possibly more than one descriptor may be derived. The goal descriptor, G_{d}, and the derived descriptor, C_{d}, are then compared in 340. If the derived descriptor does not match the goal descriptor the data signal is discarded and a next data signal will be accessed 330. If the derived descriptor matches the goal descriptor the data signal is added to a database 350 of possible data signals containing the watermark being investigated. The data signal can then be divided into one or more potentially overlapping segments 360. Each of the segments is sequentially accessed and its descriptor derived 370. The goal segment descriptor, Gₛ, and the derived segment descriptor, Csᵢ, are then compared in 380. If the derived segment descriptor does not match the goal segment descriptor, the data signal is discarded and a next segment of the data signal will be accessed 370. If the derived descriptor matches the goal descriptor, the data signal is added to a database 390 of possible segments of data signals containing the watermark being investigated.

Particular implementations of the method can consist in implementing the pre-filtering step only on the basis of a goal descriptor, only on the basis of a goal segment descriptor or both o basis of a goal descriptor and a goal segment descriptor.

In another possible implementation of the method a single individual data signal is downloaded at a time from the computer network or ECD application being investigated. The steps of descriptor derivation from the data signal, comparison to goal descriptor, segmenting the data signal and segment descriptor comparison to goal segment descriptor being executed on the downloaded data signal before another data signal is downloaded from the computer network or ECD application.

Different embodiments of the invention can be implemented according to the source in which the descriptor for the data signal is based on.

In an embodiment of the invention the descriptors are derived from the meta-data associated with the content. For instance, the user might be interested in investigating data signals that contain songs from a particular artist or record house. In this case, the meta-data tags may be used in the pre-filtering stage 220 for eliminating data signals that contain songs from other artists or record houses.

In another embodiment of the invention the descriptor may be associated with the particular representation of the data signal. For instance, the user might be interested in detecting watermarks included in data signals of high-quality content only. In that case, the bit-rate (sampling rate) of the song, which is a property of its compressed representation, may be defined as the descriptor used in the pre-filtering stage 220 for eliminating data signals that are of low quality.

In another embodiment of the invention the descriptor may be associated with the signal itself and its properties, not particularly its representation. For instance, the descriptor may be a fingerprint computed from the data signal. In this case, the matching between the goal descriptor and the descriptor obtained for an specific data signal 340 requires a search in a database of desired fingerprints. This kind of descriptor may be derived from the compressed bit-stream or the current signal representation. The fingerprint may be for example computed as a function of the Modified Discrete Cosine Transform (MDCT) coefficients which are readily available in the bit-stream of the data signal.

Furthermore different embodiments of the invention can be implemented according to the source in which the descriptor for the segments of the data signal is based on.

In one embodiment of the invention the goal segment descriptor may be associated with the certain characteristics of the segment. For instance, it could be based on the necessary existence of certain energy level in the mid-frequencies of the spectral representation of the data signal, e.g. from a Discrete Cosine Transform (DCT). Thus the goal segments descriptor may extract from the data signal those segments with a certain amount of energy in the mid-frequency coefficients of the DCT representation of the signal.

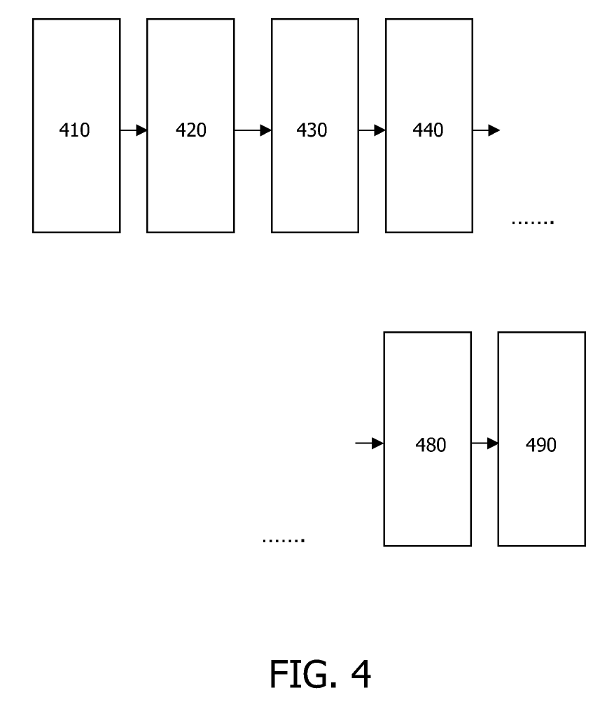

The pre-filter 220 may be composed of multiple stages of filters each successively eliminating more content for which the owner the copyright under investigation has no rights for. A schematic representation of a multi-stage pre-filter is shown in FIG. 4. A multi-stage pre-filter can consist of a cascade of individual filter stages each of them consisting of a first step that implements the actual filter using a specific descriptor 410,430,480 and a second step that stores the results containing data signals which match the specific descriptor of the filtering stage 420, 440, 490. Wherein each of the descriptors used in the different filtering can in particular, but not exclusively be derived from the meta-data associated with the content, be associated with the particular representation of the data signal or may be associated with the signal itself.

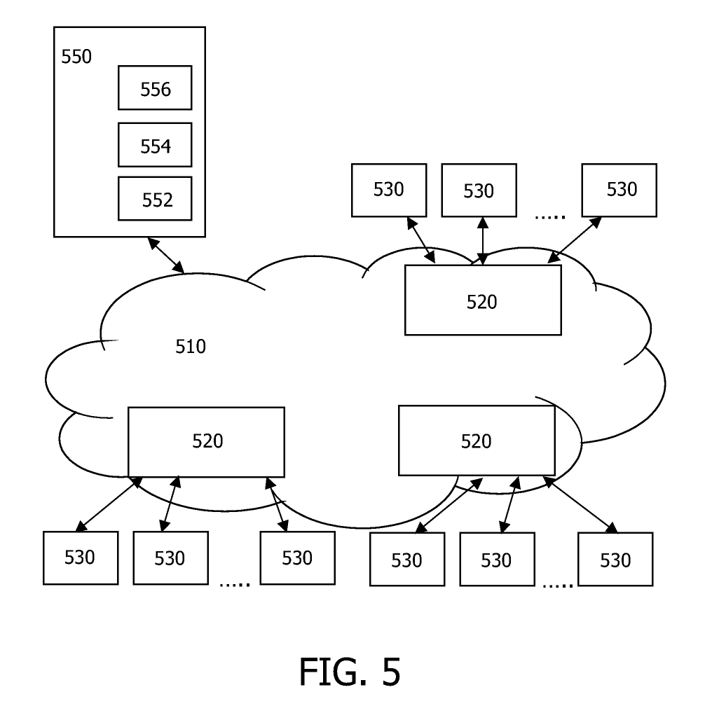

In FIG. 5 there is shown a schematic diagram illustrating a system for watermark detection and its interaction within a computer network or ECD application. The watermark detection system 550 is connected to a computer network 510, e.g. Internet, which includes a plurality of servers 520 from which individual users can download digital content, or place digital content for availability to other users of the network connected to other servers as in an ECD application. Wherein each of the individual users typically but not exclusively can have access to the server via a personal computer 530. The access means could also be a mobile phone, a palm top organizer or a local area computer network. The connection of the watermark detection system 550 to the computer network 510 may be done via a server 520.

The watermark detection system 550 comprises among other elements:

an input module for receiving a data signal (552).
a computing unit for storing or for providing access to a goal descriptor, and for detecting a watermark in the received data signal (554).
an output module for outputting a signal representing whether or not a watermark is present in the data signal (556).

The computing unit (554) may conduct the pre-filtering step (220) and the detection step (240).

In the context of the application a server might be a computer with a series of specific functionalities, e.g. security control and content access.

In one embodiment of the invention all the functions, software and hardware that allow implementing the watermark detection system are placed physically within the watermark detection system 550.

In another embodiment of the invention the pre-filter function may enclose a database or list of goal descriptors that correspond to all the contents that are to be considered in an investigation. The database in this embodiment may be located at a server 520 within the computer network 510 different to the one the watermark detection system uses for access to the network, while the pre-filtering functionality and the final watermark detection functionality are located within the watermark detection system 550. Each time a descriptor is derived from a digital content and needs to be compared to a specific goal descriptor a connection is established between the local server to which the watermark detection system is connected to and the remote server where the goal descriptor database is located at.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different distribution systems that those described above.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. A method for watermark detection, comprising:
receiving a data signal;
deriving a signal descriptor from the data signal;
comparing the signal descriptor to a goal descriptor to determine whether the data signal is a signal to be considered as a candidate data signal in the watermark detection;
detecting the watermark in the candidate data signal and otherwise disregarding the data signal.

2. The method according to claim 1, wherein the data signal is divisible into one or more segments, and wherein at least one of the segments are associated with a goal segment descriptor and a segment descriptor; further comprising
dividing the candidate data signals into one or more segments and deriving the segment descriptor for at least one of the segments;
adding a segment of the candidate data signal to a set of candidate segments for watermark detection if a derived segment descriptor matches the goal segment descriptor;
wherein watermark is detected only in the set of candidate segments.

3. A method according to claim 1, wherein the descriptor of the data signal is derived from the meta-data associated with the data signal.

4. A method according to claim 1, wherein the descriptor of the data signal is derived from properties of the data signal.

5. A method according to claim 1, wherein the descriptor of the data signal is derived from a representation of the data signal.

6. A method according to claim 1, wherein multiple filtering are performed by successively pre-filtering the data signal before watermark detection is performed on a final candidate signal.

7. (canceled)

8. A method according to claim 1, further comprising decoding a payload encoded in the watermark.

9. A method according to claim 1, wherein the goal descriptor of the data signal is kept in a database.

10. (canceled)

11. The method of claim 1, wherein the data signal comprises at least one of audio, video, images, multimedia software, multidimensional graphical models, software structures.

12. Computer readable code for implementing the method of claim 1.

13. A system for watermark detection, comprising:
an input module for receiving a data signal;
a computing unit for storing a goal descriptor, and for detecting a watermark in the received data signal; and
an output module for outputting a signal representing whether the watermark is present in the data signal;
the computing unit
receiving a data signal;
deriving a signal descriptor from the data signal;
comparing the signal descriptor to the goal descriptor to determine whether the data signal is a signal to be considered as candidate data signal in the watermark detection;
detecting the watermark in the candidate data signal, and
otherwise disregarding the data signal.
